(19) United States
(12) Patent Application Publication
(10) Pub. No.: US 2026/0104378 A1
(43) Pub. Date: Apr. 16, 2026

(54) SIGNAL MEASURING DEVICE CAPABLE OF ADJUSTING CONTACT PRESSURE AND SIGNAL MEASURING APPARATUS INCLUDING THE SAME

(71) Applicant: Samsung Electronics Co., Ltd., Suwon-si (KR)

(72) Inventors: Mikyung KIM, Suwon-si (KR); Seongjoong Kim, Suwon-si (KR); Seungkeun Yoon, Suwon-si (KR); Takhyung Lee, Suwon-si (KR); Jonghan Kim, Suwon-si (KR); Kitae Park, Suwon-si (KR); Anes Ju, Suwon-si (KR)

(73) Assignee: Samsung Electronics Co., Ltd., Suwon-si (KR)

(21) Appl. No.: 19/252,890

(22) Filed: Jun. 27, 2025

(30) Foreign Application Priority Data
Oct. 16, 2024 (KR) 10-2024-0141432

(51) Int. Cl. G01N 27/327

(52) U.S. Cl. CPC G01N 27/327

(57) ABSTRACT

A signal measuring device configured to adjust a contact pressure to an object includes an electrode layer including at least one electrode pad configured to receive an electrical signal from an object, and a first pressure channel on the electrode layer and configured to deform the electrode layer in a direction in which the electrode pad contacts the object based on pressure being applied in the first pressure channel.

### CROSS-REFERENCE TO RELATED APPLICATIONS

This application is based on and claims priority to Korean Patent Application No. 10-2024-0141432, filed on Oct. 16, 2024, in the Korean Intellectual Property Office, the disclosure of which is incorporated by reference herein in its entirety.

### BACKGROUND

### 1. Field

The disclosure relates to a signal measuring device configured to adjust a contact pressure to an object and a signal measuring apparatus including the same.

### 2. Description of Related Art

A signal measuring device may include an electrode that is able to contact an object and may collect an electrical signal output from the object. For example, the signal measuring device may sense a biosignal of a human or animal, a body organ (e.g., an organ or brain), or a biosignal of an organoid or a cell.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter

According to an aspect of the disclosure, a signal measuring device configured to adjust a contact pressure to an object may include an electrode layer including at least one electrode pad configured to receive an electrical signal from the object, and a first pressure channel on the electrode layer and configured to deform the electrode layer in a direction in which the electrode pad contacts the object based on pressure being applied in the first pressure channel.

The electrode layer may include an insulator including a front surface facing the object and a rear surface opposite to the front surface, the first pressure channel may include a channel outer wall including a side wall and a bottom wall positioned farther from the front surface than the side wall, and an elastic coefficient of the bottom wall may be less than an elastic coefficient of the insulator.

A thickness of the bottom wall may be less than a thickness of the insulator.

A material forming the bottom wall may be different than a material forming the insulator.

The at least one electrode pad may include a plurality of electrode pads, and the plurality of electrode pads may be arranged in the insulator along a direction parallel with a longitudinal direction along which the first pressure channel extends.

The first pressure channel may include a channel partition wall partitioning an internal space of the first pressure channel, a plurality of joint spaces partitioned by the channel partition wall, and a flow path configured to connect the plurality of joint spaces to each other.

The flow path may be between the channel partition wall and the insulator.

The flow path may penetrate the channel partition wall.

The at least one electrode pad may include a plurality of first electrode pads and a plurality of second electrode pads, the plurality of first electrode pads may be arranged along a first longitudinal direction in the insulator, and the plurality of second electrode pads may be arranged along a second longitudinal direction that intersects with the first longitudinal direction in the insulator.

The signal measuring device may include a second pressure channel extending along in a third longitudinal direction that intersects a fourth longitudinal direction along which the first pressure channel extends.

Each of the first pressure channel and the second pressure channel may include a channel partition wall partitioning an internal space of the respective pressure channel, a plurality of joint spaces partitioned by the channel partition wall, and a flow path configured to connect the plurality of joint spaces to each other.

More than half of the plurality of joint spaces of the first pressure channel may not overlap the second pressure channel.

Based on a thickness direction of the electrode layer, the channel partition wall of the first pressure channel may overlap the second pressure channel.

The first pressure channel and the second pressure channel may intersect each other at a same height.

The first pressure channel and the second pressure channel may share a shared channel partition wall, a first flow path extending in the fourth longitudinal direction along which the first pressure channel extends and a second flow path extending in the third longitudinal direction along which the second pressure channel extends may be in the shared channel partition wall, the first flow path may not connected to the second flow path.

The electrode layer further may include a plurality of holes penetrating the insulator, and the insulator includes a mesh structure.

Based on a thickness direction of the electrode layer, an area in which the first pressure channel is overlapped by the plurality of holes may be less than 50% of a total area of the plurality of holes.

An area of the plurality of holes may include along a radially outward direction from a center of the electrode layer.

According to an aspect of the disclosure, a signal measuring apparatus configured to adjust a contact pressure to an object may include a signal measuring device including an electrode layer including an electrode pad configured to receive an electrical signal from the object and a pressure channel configured to deform the electrode layer in a direction in which the electrode pad contacts the object based on pressure being applied in the pressure channel, a pressure application device configured to supply fluid to the pressure channel, and a controller configured to control the pressure application device.

The controller may be configured to control the pressure application device to increase pressure of the pressure channel based on an electrical signal obtained from the electrode pad being less than a set value.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram of a signal measuring apparatus configured to adjust a contact pressure to an object according to one or more embodiments;

FIG. 2 is a diagram illustrating a pressure channel according to one or more embodiments;

FIG. 3 is a diagram illustrating an example in which a signal measuring device contacts an object according to one or more embodiments;

FIG. 4 is a diagram illustrating a pressure channel according to one or more embodiments;

FIG. 5 is a diagram illustrating a pressure channel according to one or more embodiments;

FIGS. 6A and 6B are diagrams illustrating an example in which a pressure channel is deformed by pressure according to one or more embodiments;

FIG. 7 is a diagram illustrating an example in which a signal measuring device contacting an object according to one or more embodiments;

FIG. 8 is a diagram illustrating a pressure channel according to one or more embodiments;

FIG. 9 is a plan view of a signal measuring device configured to adjust a contact pressure to an object according to one or more embodiments;

FIG. 10 is a rear view of a signal measuring device configured to adjust a contact pressure to an object according to one or more embodiments;

FIG. 11 is a cross-sectional view taken along line I-I of FIGS. 9 and 10, according to one or more embodiments;

FIG. 12 is a diagram illustrating an example in which a plurality of pressure channels is disposed according to one or more embodiments;

FIG. 13 is a diagram illustrating an example in which a plurality of pressure channels is disposed according to one or more embodiments;

FIG. 14 is a diagram illustrating an example in which a plurality of pressure channels is disposed according to one or more embodiments.

FIG. 15 is a diagram illustrating an example in which a signal measuring device contacting an object according to one or more embodiments;

FIG. 16 is a plan view of a signal measuring device configured to adjust a contact pressure to an object according to one or more embodiments;

FIG. 17 is a plan view of a signal measuring device configured to adjust a contact pressure to an object according to one or more embodiments;

FIG. 18 is a plan view of a signal measuring device configured to adjust a contact pressure to an object according to one or more embodiments;

FIG. 19 is a flowchart illustrating a method of manufacturing a signal measuring device configured to adjust a contact pressure to an object according to one or more embodiments; and

FIG. 20 is a diagram illustrating a method of manufacturing a signal measuring device capable of contact pressure adjustment according to one or more embodiments.

### DETAILED DESCRIPTION

Reference will now be made in detail to embodiments, examples of which are illustrated in the accompanying drawings. In this regard, the present embodiments may have different forms and should not be construed as being limited to the descriptions set forth herein. Accordingly, the embodiments are merely described below, by referring to the figures, to explain aspects.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments will be described in detail with reference to the accompanying drawings. When describing the embodiments with reference to the accompanying drawings, like reference numerals refer to like elements and a repeated description related thereto will be omitted.

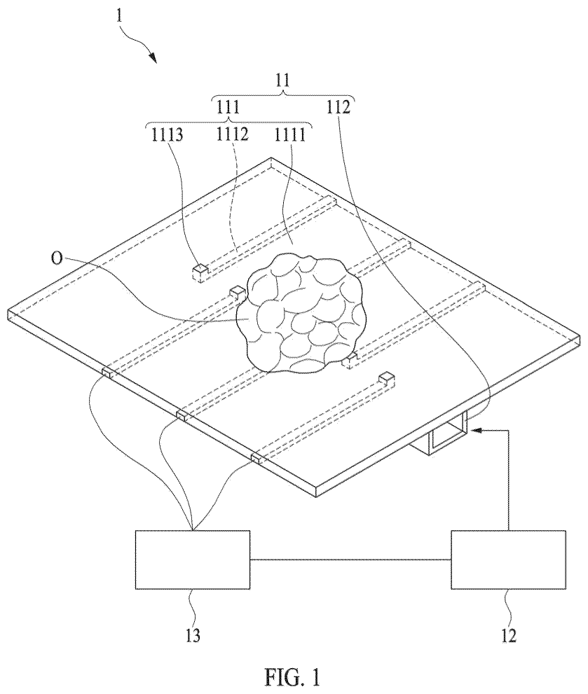

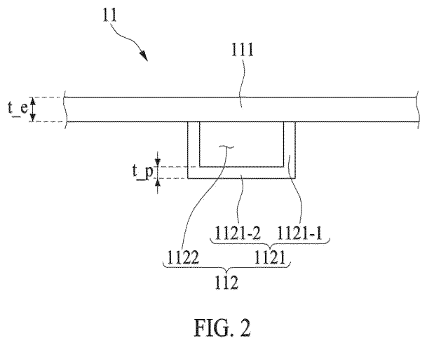

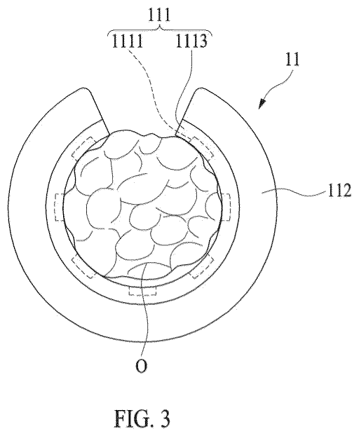

FIG. 1 is a diagram of a signal measuring apparatus configured to adjust a contact pressure to an object according to one or more embodiments. FIG. 2 is a diagram illustrating a pressure channel according to one or more embodiments. FIG. 3 is a diagram illustrating an example in which a signal measuring device contacts an object according to one or more embodiments.

Referring to FIGS. 1 to 3, a signal measuring apparatus 1 configured to adjust a contact pressure to an object according to one or more embodiments may collect an electrical signal output from an object O through an electrode. For example, the object O may include a body organ (e.g., an organ or brain) of a human or animal, an organoid, or a cell. The organoid may be an organ-like structure generated by culturing or recombining stem cells in three dimensions (3D) and may also be referred to as a “mini-organ” or a “pseudo-organ”. The organoid may be assessed as an in vitro test model suitable for studying various and complex characteristics of the human brain and the importance of research using the organoid may increase since the organoid is suitable for studying characteristics of a human nervous system. By using the signal measuring apparatus 1 according to one or more embodiments, biosignals (e.g., neural signals) may be collected in multiple channels through a plurality of electrode pads from the 3D structured object O in a non-invasive manner. For example, to collect a signal for a specific part of the object O using the limited number of electrode pads disposed on a limited location, the electrode pads may need to be accurately aligned in the specific part. When using the signal measuring apparatus 1 according to one or more embodiments, the difficulty of alignment described above may be mitigated since the electrode pads may be installed in a wide area (e.g., all areas) of the object O. The signal measuring apparatus 1 according to one or more embodiments may be able to adjust contact pressure between the plurality of electrode pads and the object O through pressure application, and accordingly, each electrode pad may contact the object O at an appropriate pressure. For example, the signal measuring apparatus 1 may include a signal measuring device 11, a pressure application device 12, and a controller 13.

As the shape of the signal measuring device 11 is deformed by pressure applied to the signal measuring device 11, the pressure at a position at which the signal measuring device 11 contacts the object O may be adjusted. The signal measuring device 11 may include an electrode layer 111 and a pressure channel 112.

The electrode layer 111 may include an electrode that may contact the object O. For example, when no external force is applied, the electrode layer 111 may have a flat shape. As shown in the drawings, the electrode layer 111 may have a rectangular shape, but the shape of the electrode layer 111 is not limited thereto. The electrode layer 111 may include an insulator 1111, an electrode line 1112, and an electrode pad 1113.

The insulator 1111 may include a front surface (the upper side surface in FIG. 2) disposed to face the object O and a rear surface (the lower side surface in FIG. 2) disposed opposite to the front surface. Because the insulator 1111 is formed of an electrically insulating material, shorting of the electrode line 1112 or the electrode pad 1113 by another adjacent electrode line 1112 and/or another electrode pad 1113 may be reduced or prevented. The insulator 1111 may be deformed in response to a shape change of the pressure channel 112 as the insulator 1111 is formed of a flexible material. For example, the insulator 1111 may be formed of a polymeric silicone material (e.g., polydimethyl siloxane (PDMS)), a photoresist (e.g., SU-8), parylene (e.g., parylene C), or polyimide.

The electrode line 1112 may transmit the electrical signal obtained from the electrode pad 1113 to the outside (e.g., the controller 13 or a wire connected to the controller 13). For example, at least a portion of the electrode lines 1112 may be embedded in the insulator 1111. For example, the plurality of electrode lines 1112 may be respectively connected to the plurality of electrode pads 1113. For example, to prevent the electrical signals transmitted along the plurality of electrode lines 1112 from interfering with each other, directions in which adjacent electrode lines 1112 of the plurality of electrode lines 1112 extend from electrode pads 1113 connected thereto may be opposite to each other, but embodiments are not limited thereto. That is, each electrode line 1112 may extend in a lateral direction that is opposite to the lateral direction extension of an adjacent electrode line 1112, and the electrode pads 1113 extend from an end of the electrode line 1112 in a direction that is perpendicular to the lateral direction toward the front surface of the electrode layer 111. For example, an electrode line 1112 may be embedded at a different height in the insulator 1111 than an adjacent electrode line 1112. The electrode line 1112 may be formed of a material with high electrical conductivity (e.g., metal). For example, the electrode line 1112 may be formed of liquid metal that exists in a liquid state at or near room temperature. According to one or more embodiments, a problem of the electrode line 1112 being disconnected may be reduced while increasing the flexibility of the signal measuring device 11.

The electrode pad 1113 may receive an electrical signal output from the object O. For example, the plurality of electrode pads 1113 may be disposed in the insulator 1111. For example, the plurality of electrode pads 1113 may be disposed along a direction parallel with a longitudinal direction of the pressure channel 112. According to one or more embodiments, when the pressure channel 112 is deformed, each of the plurality of electrode pads 1113 may be displaced in a direction to contact the object O. For example, the plurality of electrode pads 1113 may be disposed above the pressure channel 112 based on a thickness direction (e.g., the vertical direction of FIG. 2) of the insulator 1111. The arrangement structure described above is an example, and the plurality of electrode pads 1113 may be arranged in a direction intersecting with the longitudinal direction of the pressure channel 112. For example, a plurality of pressure channels 112 may be disposed in a direction diagonally intersecting with the direction in which the plurality of electrode pads 1113 is arranged. According to one or more embodiments, when the pressure channel 112 is deformed, each of the plurality of electrode pads 1113 may approach the object O in a direction toward the object O to contact the object O.

When the pressure is applied to the electrode layer 111, the pressure channel 112 may deform, causing the shape of the electrode layer 111 to deform to allow the electrode pads 1113 to approach the object O in a contact direction. The principle of deformation of the pressure channel 112 in a specific direction is described below. The pressure channel 112 may be provided in the electrode layer 111. For example, the pressure channel 112 may be provided on the rear surface of the electrode layer 111 but embodiments are not limited thereto. For example, the pressure channel 112 may be embedded in the side surface of the electrode layer 111 or inside the electrode layer 111. For example, the pressure channel 112 may include a channel outer wall 1121 and a pressure application inlet 1122.

The channel outer wall 1121 may be a portion that encloses at least a portion or an entirety of an internal space of the pressure channel 112 and may reduce loss of pressure to the outside when pressure is applied to the inside of the pressure channel 112 through the pressure application inlet 1122. For example, a portion of the channel outer wall 1121 is open and the open portion may be covered by a portion (e.g., the rear surface) of the insulator 1111. For example, the channel outer wall 1121 may be provided on the rear surface of the insulator 1111 but is not limited thereto. For example, the channel outer wall 1121 may be embedded inside the insulator 1111. For example, the channel outer wall 1121 may be integrally formed with the insulator 1111, having the same material as the insulator 1111.

An elastic coefficient of a bottom wall 1121-2 of the channel outer wall 1121 positioned farthest from the front surface of the insulator 1111 (i.e., farther than the side walls 1121-1) may be lower than an elastic coefficient of the insulator 1111. For example, thickness t_p of the bottom wall 1121-2 may be less than thickness t_e of the electrode layer 111 or the insulator 1111. For example, an elastic coefficient of a material forming the bottom wall 1121-2 may be less than an elastic coefficient of a material forming the insulator 1111. According to one or more embodiment, when the pressure is applied to the pressure channel 112, the bottom wall 1121-2 of the channel outer wall 1121 may expand more than the other portions (i.e. side walls 1121-1) and due to the expansion difference, at least a portion of an edge portion of the insulator 1111 may bend in an opposite direction to the bottom wall 1121-2, and thereby, the electrode pad 1113 may contact the object O.

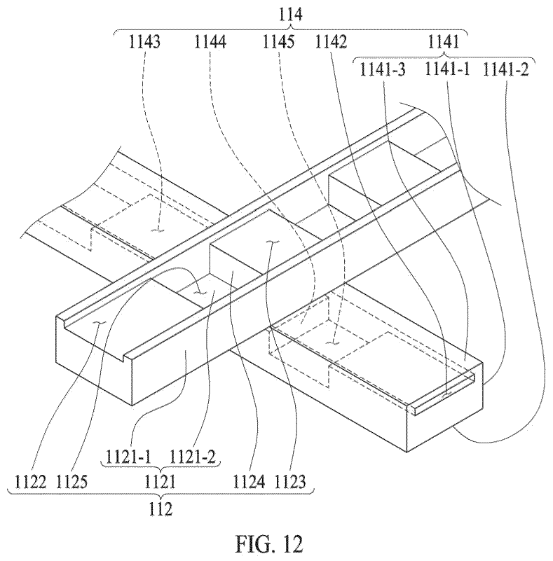

For example, the channel outer wall 1121 may be formed as a pillar shape having a rectangular cross-section. For example, the channel outer wall 1121 may include a side wall 1121-1 and the bottom wall 1121-2. The bottom wall 1121-2 may be a portion of the channel outer wall 1121 positioned farthest from the front surface of the insulator 1111. The side wall 1121-1 may connect the bottom wall 1121-2 to the insulator 1111. Hereinafter, a case in which the channel outer wall 1121 has a rectangular cross-section is described as an example, but the shape of the channel outer wall 1121 is not limited thereto. In addition, FIGS. 1 to 3 illustrate that the upper part of the channel outer wall 1121 is open and the open upper part is covered by the rear surface of the insulator 1111. However, as described below, the channel outer wall 1121 may include a top wall (e.g., 1141-3 of FIG. 12) separate from the insulator 1111. In the cases of FIGS. 1 to 3, a portion of the insulator 1111 may be the top wall of the channel outer wall 1121.

The pressure application device 12 may generate pressure that is applied to the pressure channel 112 of the signal measuring device 11. For example, the pressure application device 12 may include a compressor, a pump, a gas cylinder, and/or a pressure tank.

The controller 13 may control the pressure application device 12. For example, the controller 13 may control power supplied to the pressure application device 12 or may adjust a flow rate of fluid transmitted from the pressure application device 12 to the signal measuring device 11. The controller 13 may collect an electrical signal output from each part of the object O through the electrode line 1112 (e.g., each part of the object O that is contacted by an electrode pad 1113). For example, the controller 13 may control the pressure application device 12 based on the obtained electrical signal.

For example, when an electrical signal obtained from the electrode pad 1113 is less than a first set value, the controller 13 may control the pressure application device 12 to increase the pressure of the pressure channel 112. Through this control scheme, the electrode pad 1113 may contact the object O at sufficient pressure to ensure the electrical signal of the object O transmitted to the electrode pad 1113 has sufficient intensity.

For example, when the electrical signal obtained from the electrode pad 1113 is greater than or equal to the first set value, the controller 13 may control the pressure application device 12 not to increase the pressure of the pressure channel 112 any further. For example, when the electrical signal obtained from the electrode pad 1113 exceeds a second set value, the controller 13 may control the pressure application device 12 to decrease the pressure of the pressure channel 112. For example, the second set value may be greater than the first set value. Through the control scheme described above, a problem of damage to the object O may be reduced as the electrode pad 1113 excessively presses the object O.

According to the signal measuring device 11 in one or more embodiments, while reducing damage to the object O, a signal of the object O may be efficiently measured by providing appropriate contact pressure to the object O. For example, for the object O (e.g., an organoid) that grows over time, the signal measuring device 11 may be deformed based on a growth process. Accordingly, a biosignal of the object O may be continuously measured without replacing the signal measuring device 11.

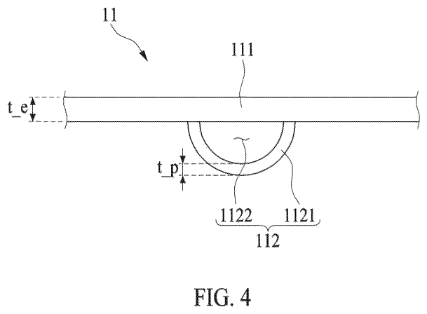

FIG. 4 is a diagram illustrating a pressure channel according to one or more embodiments.

Referring to FIG. 4, the pressure channel 112 according to one or more embodiments may include an electrode layer 111 and the pressure channel 112. For example, the pressure channel 112 may include a channel outer wall 1121 and a pressure application inlet 1122.

For example, the channel outer wall 1121 may be formed as a pillar shape having a semicircular cross-section. In this case, a portion of the channel outer wall 1121 positioned farthest from the front surface of the insulator 1111 may be referred to as a “bottom wall” and the other portion may be referred to as a “side wall”. The elastic coefficient of the bottom wall 1121-2 may be less than the elastic coefficient of the insulator 1111. For example, thickness t_p of the bottom wall may be less than thickness t_e of the electrode layer 111 or the insulator 1111.

The shape of the channel outer wall 1121 shown in FIGS. 2 and 4 is an example and the channel outer wall 1121 may have various shapes (e.g., a cylindrical shape or a triangular prism shape).

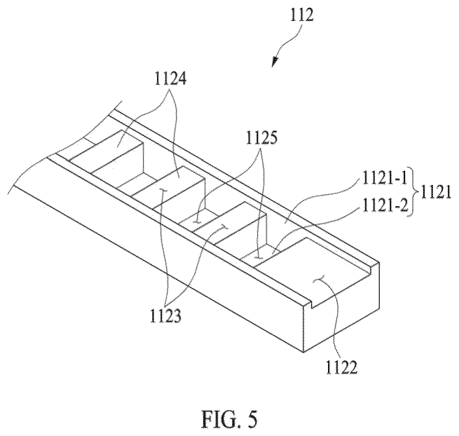

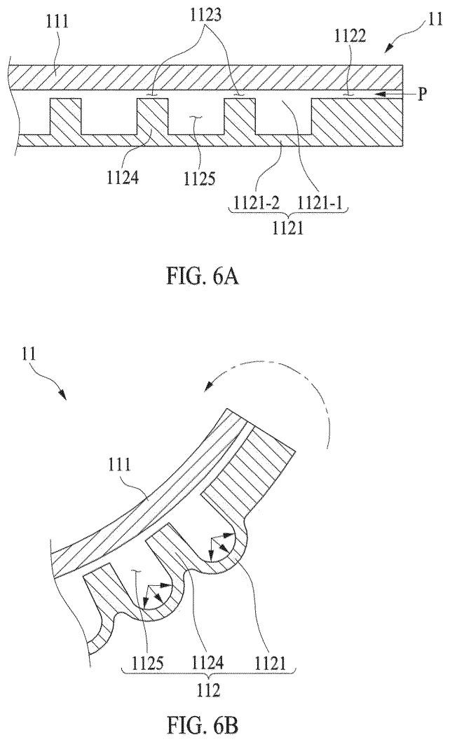

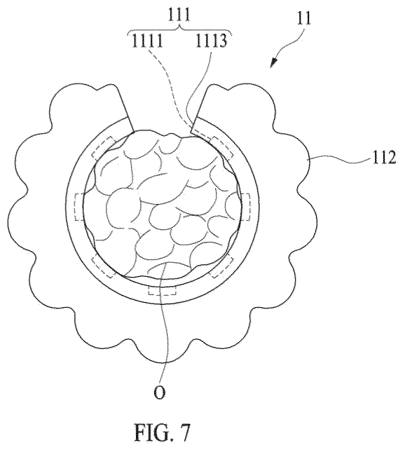

FIG. 5 is a diagram illustrating a pressure channel according to one or more embodiments. FIGS. 6A and 6B are diagrams illustrating an example in which a pressure channel is deformed by pressure according to one or more embodiments. FIG. 7 is a diagram illustrating an example in which a signal measuring device contacting an object according to one or more embodiments.

Referring to FIGS. 5 to 7, the signal measuring device 11 according to one or more embodiments may include the electrode layer 111 and the pressure channel 112. For example, the electrode layer 111 may include the insulator 1111, an electrode line (e.g., 1112 of FIG. 1), and the electrode pad 1113. For example, the pressure channel 112 may include the channel outer wall 1121, the pressure application inlet 1122, a flow path 1123, a channel partition wall 1124, and a plurality of joint spaces 1125. For example, the channel outer wall 1121 may include a side wall 1121-1 and the bottom wall 1121-2.

The pressure application inlet 1122 may be formed at, for example, one of both ends of the pressure channel 112, but is not limited thereto. For example, the pressure application inlet 1122 may be formed in a direction parallel with the longitudinal direction of the pressure channel 112, but is not limited thereto. For example, the pressure application inlet 1122 may also be formed on the side wall 1121-1 or the bottom wall 1121-2 of the channel outer wall 1121.

The channel partition wall 1124 may partition the internal space of the pressure channel 112. For example, the channel partition wall 1124 may protrude from the bottom wall 1121-2. For example, the channel partition wall 1124 may contact a surface of the bottom wall 1121-1. For example, the side surface of the channel partition wall 1124 may contact a surface of the side wall 1121-1. For example, the plurality of channel partition walls 1124 may be disposed on the bottom wall 1121-1 while being spaced apart from each other in the longitudinal direction of the pressure channel 112.

The plurality of joint spaces 1125 may be partitioned by the channel partition wall 1124. For example, a portion in which the channel partition wall 1124 is not formed in the pressure channel 112 may be referred to as the joint space 1125. When the pressure is applied to the pressure channel 112, in the pressure channel 112, the bottom wall 1121-2 of the joint space 1125 having a relatively thin thickness may expand more than the other portions. Accordingly, as shown in FIG. 6B, as the pressure channel 112 is deformed in a direction in which a pair of channel partition walls 1124 adjacent to the respective joint space 1125 approaches each other, the electrode layer 111 connected to the pressure channel 112 may also be deformed, and deformations 1121b may be formed in each of the joint spaces 1125.

The flow path 1123 may connect the plurality of the joint spaces 1125 to each other. For example, the flow path 1123 may be formed between a partition wall and the insulator 1111. For example, the top surface of the channel partition wall 1124 may be spaced apart from the insulator 1111. In this case, a space between the top surface of the channel partition wall 1124 and the insulator 1111 may be the flow path 1123. The flow path 1123 may not need to be formed between the partition wall and the insulator 1111 and the flow path 1123 may be formed to penetrate the channel partition wall 1124 in the longitudinal direction of the pressure channel 112. According to the flow path 1123, the same or similar pressure may be applied to each of the plurality of joint spaces 1125. For example, the plurality of joint spaces 1125 connected by the flow path 1123 may expand at a similar level. As each of the plurality of joint spaces 1125 expands, the electrode layer 111 may be deformed into a shape enclosing the object O as shown in FIG. 7. As a result, depending on the intensity of pressure applied to the pressure channel 112, the intensity of the contact pressure at which the electrode pad 1113 contacts the object O may be adjusted.

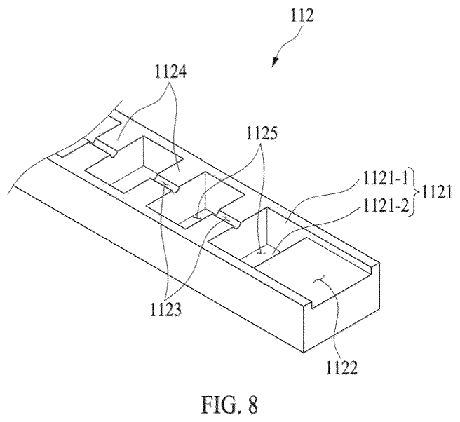

FIG. 8 is a diagram illustrating a pressure channel according to one or more embodiments.

Referring to FIG. 8, the pressure channel 112 according to one or more embodiments may include the channel outer wall 1121, the pressure application inlet 1122, the flow path 1123, the channel partition wall 1124, and the plurality of joint spaces 1125. For example, the channel outer wall 1121 may include a side wall 1121-1 and the bottom wall 1121-2.

For example, the channel partition wall 1124 may contact a surface of the bottom wall 1121-1. For example, the side surface of the channel partition wall 1124 may contact a surface of the side wall 1121-1. For example, the top surface of the channel partition wall 1124 may contact a rear surface of an insulator (e.g., 1111 of FIG. 1).

For example, the flow path 1123 may have a groove shape recessed from the top surface of the channel partition wall 1124. For example, the width of the flow path 1123 may be less than or equal to ⅓ of the width of the channel partition wall 1124. For example, based on a direction perpendicular to the longitudinal direction of the pressure channel 112, a cross-sectional area of the flow path 1123 may be less than or equal to 1/9 of the cross-sectional area of the channel partition wall 1124. As described above, by sufficiently reducing the cross-sectional area of the flow path 1123 compared to the channel partition wall 1124, the rigidness of the channel partition wall 1124 may increase. As the rigidness of the channel partition wall 1124 increases, a ratio of utilizing the pressure applied to the pressure channel 112 to deform the bottom wall 1121-2 may increase. For example, through the structure described above, the responsiveness of a signal measuring device (e.g., 11 of FIG. 1) may be improved or the intensity of pressure required to deform the signal measuring device 11 may be reduced.

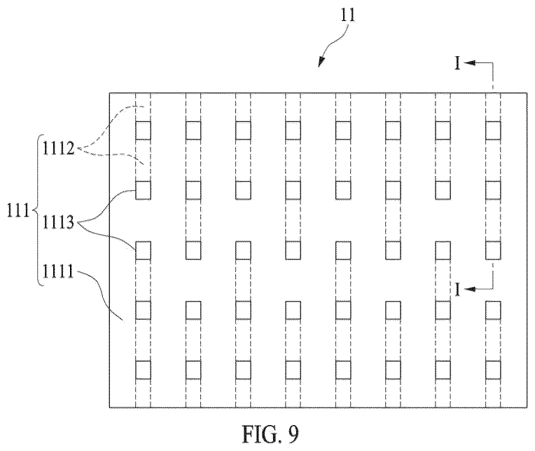

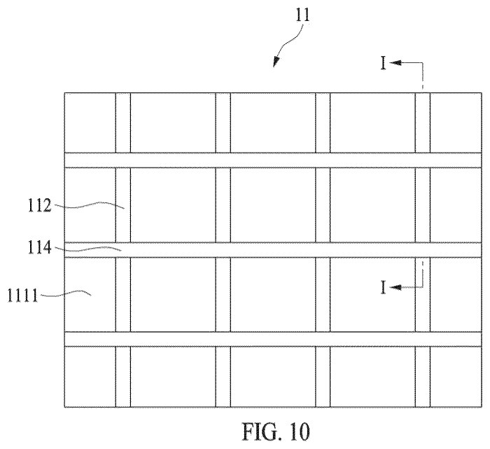

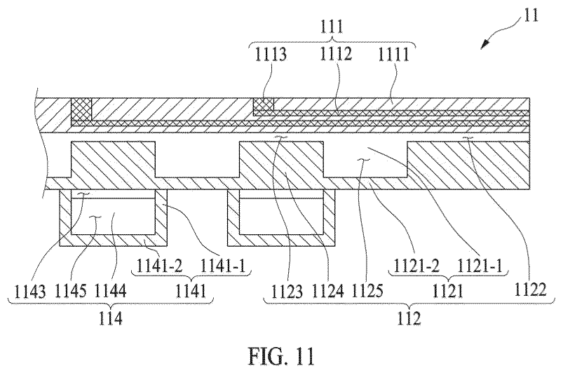

FIG. 9 is a plan view of a signal measuring device configured to adjust a contact pressure to an object according to one or more embodiments. FIG. 10 is a rear view of a signal measuring device configured to adjust a contact pressure to an object according to one or more embodiments. FIG. 11 is a cross-sectional view taken along line I-I of FIGS. 9 and 10. FIG. 12 is a diagram illustrating an example in which a plurality of pressure channels is disposed according to one or more embodiments.

Referring to FIGS. 9 to 12, the signal measuring device 11 according to one or more embodiments may include an electrode layer 111 and a plurality of pressure channels 112 and 114. For example, the electrode layer 111 may include the insulator 1111, the electrode line 1112, and the electrode pad 1113.

The plurality of electrode pads 1113 may be arranged, for example, in a plurality of rows and columns. For example, some of the plurality of electrode pads 1113 may be disposed in the insulator 1111 along a first longitudinal direction (e.g., the vertical direction of FIG. 9). For example, some of the plurality of electrode pads 1113 may be disposed in the insulator 1111 along a second longitudinal direction (e.g., the horizontal direction of FIG. 9) intersecting with the first longitudinal direction described above. Through the arrangement described above, electrical signals may be simultaneously collected from various parts of an object (e.g., object O of FIG. 1).

The plurality of electrode lines 1112 connected to the plurality of electrode pads 1113, respectively, may be insulated. For example, some of the plurality of electrode lines 1112 may be disposed not to overlap each other in the thickness direction of the insulator 1111. For example, as shown in FIG. 11, the plurality of electrode lines 1112 may be positioned at different heights on the insulator 1111 and the insulator 1111 may be disposed between adjacent electrode lines 1112.

The plurality of pressure channels 112 and 114 may include the first pressure channel 112 and the second pressure channel 114 arranged along in a direction intersecting with the longitudinal direction of the first pressure channel 112. FIG. 10 illustrates a case in which the first pressure channel 112 and the second pressure channel 114 intersect with each other at right angles as an example, but embodiments are not limited thereto. The plurality of pressure channels 112 and 114 may be disposed to intersect at various angles (e.g., 45 degrees or 60 degrees). For example, three or more pressure channels may be disposed to intersect at different angles. For example, the plurality of pressure channels may be radially disposed. For example, the plurality of pressure channels 112 and 114 may include a plurality of first pressure channels 112 disposed along a first direction (e.g., the vertical direction of FIG. 10) and a plurality of second pressure channels 114 disposed along a second direction (e.g., the horizontal direction of FIG. 10). As the plurality of pressure channels 112 and 114 are disposed to intersect with each other, the plurality of electrode pads 1113 disposed on the insulator 1111 may contact the object O.

For example, the first pressure channel 112 may include the channel outer wall 1121, the pressure application inlet 1122, a flow path 1123, a channel partition wall 1124, and a plurality of joint spaces 1125. For example, the channel outer wall 1121 may include a side wall 1121-1 and the bottom wall 1121-2.

For example, the second pressure channel 114 may include a channel outer wall 1141, a pressure application inlet 1142, a flow path 1143, a channel partition wall 1144, and a plurality of joint spaces 1145. For example, the channel outer wall 1141 may include a side wall 1141-1, a bottom wall 1141-2, and a top wall 1141-3. Unless otherwise described, the description of components of the first pressure channel 112 may apply to the components of the second pressure channel 114 and any repeated description may be omitted.

According to one or more embodiments, the top wall 1141-3 may be a portion enclosing an upper part of an internal space of the second pressure channel 114 and may reduce loss, to the outside, of pressure applied to the inside of the second pressure channel 114. A portion of the top wall 1141-3 may be fixed to, for example, the bottom wall 1121-2 of the first pressure channel 112. For example, an elastic coefficient of the top wall 1141-3 may be greater than an elastic coefficient of the bottom wall 1141-2 of the second pressure channel 114. According to one or more embodiments, when the pressure is applied to the second pressure channel 114, the bottom wall 1141-2 may expand more than the top wall 1141-3 and due to the expansion difference, a portion of an edge portion of the insulator 1111 may bend in the opposite direction to the bottom wall 1141-2. For example, the top wall 1141-3 and the bottom wall 1141-2 may be formed of different materials and an elastic coefficient of the material forming the top wall 1141-3 may be greater than an elastic coefficient of the material forming the bottom wall 1141-2.

The top wall 1141-3 may be fixed to the rear surface of the insulator 1111. For example, the thickness of the top wall 1141-3 may vary by area. For example, in the top wall 1141-3, the thickness of at least a partial portion that is not overlapped by the first pressure channel 112 in the thickness direction of the insulator 1111 may be thicker than a portion that is overlapped by the first pressure channel 112 and may be fixed to the rear surface of the insulator 1111. According to one or more embodiments, even if the top wall 1141-3 and the bottom wall 1141-2 are formed of the same material, when the pressure is applied to the second pressure channel 114, the bottom wall 1141-2 may expand more than the top wall 1141-3 and due to the expansion difference, a portion of the edge of the insulator 1111 may bend in the opposite direction to the bottom wall 1141-2.

According to one or more embodiments, as shown in FIGS. 11 and 12, the second pressure channel 114 may be disposed to be overlapped by the channel partition wall 1124 of the first pressure channel 112 based on the thickness direction (e.g., the vertical direction of FIG. 11) of the electrode layer 111. For example, based on the thickness direction (e.g., the vertical direction of FIG. 11) of the electrode layer 111, 50% or more (e.g., 80%, 90%, or 100%) of the joint space 1125 of the first pressure channel 112 may not overlap the second pressure channel 114. According to one or more embodiments, the problem of interference by the second pressure channel 112 may be reduced while the bottom wall 1121-2 of the joint space 1125 of the first pressure channel 112 expands.

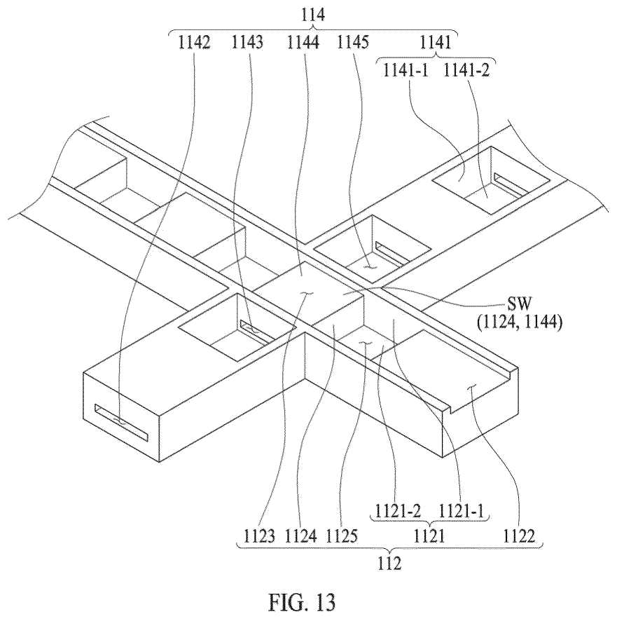

FIG. 13 is a diagram illustrating an example in which a plurality of pressure channels is disposed according to one or more embodiments.

Referring to FIG. 13, the plurality of pressure channels 112 and 114 according to one or more embodiments may include the channel outer walls 1121 and 1141, the pressure application inlets 1122 and 1142, the flow paths 1123 and 1143, the channel partition walls 1124 and 1144, and the plurality of joint spaces 1125 and 1145. For example, the channel outer walls 1121 and 1141 may include the side walls 1121-1 and 1141-1 and the bottom walls 1121-2 and 1141-2, respectively.

According to one or more embodiments, the first pressure channel 112 and the second pressure channel 114 may be formed to intersect at the same height. For example, the first pressure channel 112 may be formed across the channel partition wall 1144 of the second pressure channel 114. For example, the second pressure channel 114 may be formed across the channel partition wall 1124 of the first pressure channel 112. In other words, the first pressure channel 112 and the second pressure channel 114 may share the same partition walls 1124 and 1144. The structure described above may allow for a reduction in the total height of the plurality of pressure channels 112 and 114. In this case, the same channel partition walls 1124 and 1144 described above may be referred to as a shared wall SW.

Both the first flow path 1123 extending in the longitudinal direction of the first pressure channel 112 and the second flow path 1143 extending in the longitudinal direction of the second pressure channel 114 may be formed in the shared wall SW. Through the structure described above, fluid may move to each of the pressure channels 112 and 114 while the pressure channels 112 and 114 structurally share the same channel partition walls 1124 and 1144.

The first flow path 1123 and the second flow path 1143 formed on the shared wall SW may not be connected to each other. Through the structure described above, different pressures may be applied to the pressure channels 112 and 114, as necessary. For example, the first flow path 1123 may be formed outside of the shared wall SW and the second flow path 1143 may be formed across the inside of the shared wall SW. That is, the second flow path 1143 may be formed to extend under the shared wall SW while the first flow path 1123 may be formed to extend over the shared wall SW. However, embodiments are not limited thereto.

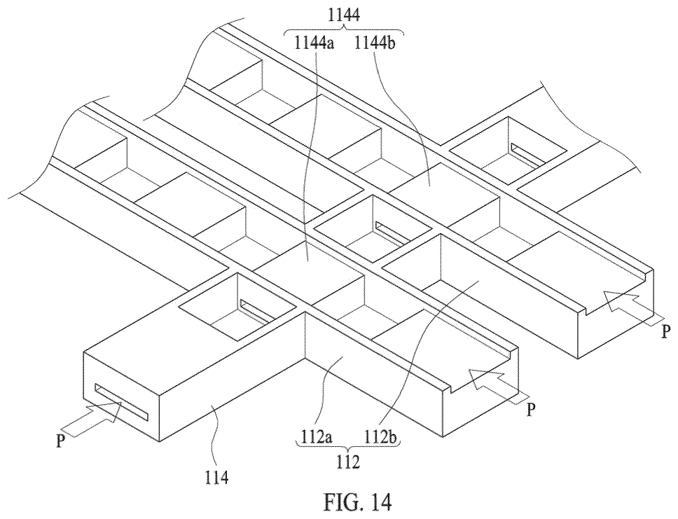

FIG. 14 is a diagram illustrating an example in which a plurality of pressure channels is disposed according to one or more embodiments.

Referring to FIG. 14, according to one or more embodiments, the first pressure channel 112 and the second pressure channel 114 may be formed to intersect with each other at the same height. For example, the first pressure channel 112 may include a plurality of pressure channels 112a and 112b disposed across the second pressure channel 114. For example, a first-first pressure channel 112a and a first-second pressure channel 112b may be respectively disposed across different channel partition walls 1144a and 1144b of the plurality of channel partition walls 1144 provided at the second pressure channel 114. For example, the second pressure channel 114 may include the plurality of channel partition walls 1144a and 1144b sharing with the plurality of pressure channels 112a and 112b disposed in a direction intersecting with the longitudinal direction of the second pressure channel 114.

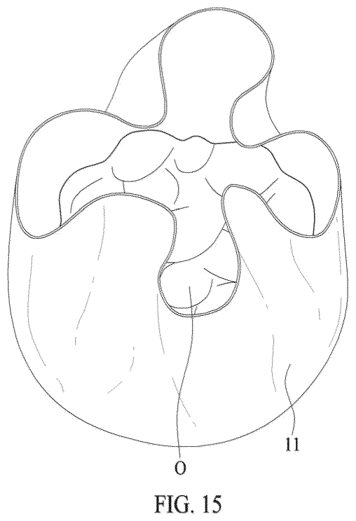

FIG. 15 is a diagram illustrating an example in which a signal measuring device contacting an object according to one or more embodiments. FIG. 15 illustrates an example in which a pressure channel (e.g., 112 and/or 114 of FIGS. 1 to 14) is omitted.

Referring to FIG. 15, the signal measuring device 11 according to one or more embodiments may enclose the object O in various directions (e.g., all directions) by the pressure applied to a pressure channel. In this process, a plurality of electrode pads provided in the signal measuring device 11 may contact the object O.

When the signal measuring device 11 has a two-dimensional flat shape, while the signal measuring device 11 encloses the object O having a 3D stereoscopic shape, wrinkles according to material deformation of the signal measuring device 11 may be formed. Such wrinkles may hinder the electrode pad provided in the signal measuring device 11 from contacting the object O. To reduce the wrinkles, a hole may be formed in the signal measuring device 11. Hereinafter, the signal measuring device 11 having a structure with a hole is described as an example with reference to the drawings.

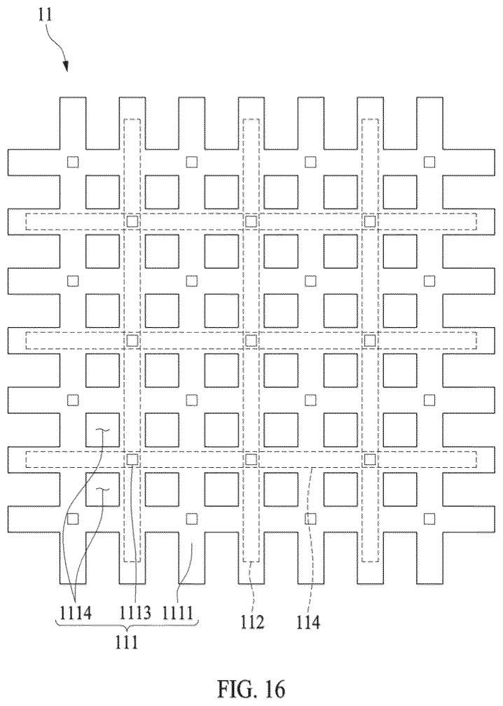

FIG. 16 is a plan view of a signal measuring device configured to adjust a contact pressure to an object according to one or more embodiments.

Referring to FIG. 16, the signal measuring device 11 according to one or more embodiments may include the electrode layer 111 and the pressure channels 112 and 114. The electrode layer 111 may include the insulator 1111, an electrode line (e.g., 1112 of FIG. 1), the electrode pad 1113, and a hole 1114. The pressure channels 112 and 114 may include the first pressure channel 112 and the second pressure channel 114 disposed and extending in different directions.

For example, a plurality of holes 1114 may be formed to penetrate in the thickness direction of the insulator 1111. Through the configuration described above, the insulator 1111 may be formed in a mesh structure. According to the mesh structure, the flexibility of the insulator 1111 may increase. In addition, since wrinkles formed when the signal measuring device 11 is deformed by the pressure applied to the pressure channels 112 and 114 may be reduced, the electrode pad 1113 may more smoothly contact an object (e.g., O of FIG. 1).

According to one or more embodiments, based on the thickness direction of the electrode layer 111, an overlapping area of the pressure channels 112 and 114 with the plurality of holes 1114 may be less than 50% (e.g., less than 20% or less than 10%) of the total area of the plurality of holes 1114. According to one or more embodiments, the wrinkles formed when the signal measuring device 11 is deformed may be reduced. For example, based on the thickness direction of the electrode layer 111, the pressure channels 112 and 114 may not overlap the plurality of holes 1114.

For example, the plurality of pressure channels 112 and 114 may include a plurality of first pressure channels 112 disposed while being spaced apart from each other in a first direction (e.g., the vertical direction of FIG. 16) and a plurality of second pressure channels 114 disposed while being spaced apart from each other in a second direction (e.g., the horizontal direction of FIG. 16). For example, the first pressure channel 112 and the second pressure channel 114 may be disposed in the vertical direction at different heights as shown in FIGS. 11 and 12. As another example, the first pressure channel 112 and the second pressure channel 114 may be disposed to intersect with each other at the same height as shown in FIGS. 13 and 14.

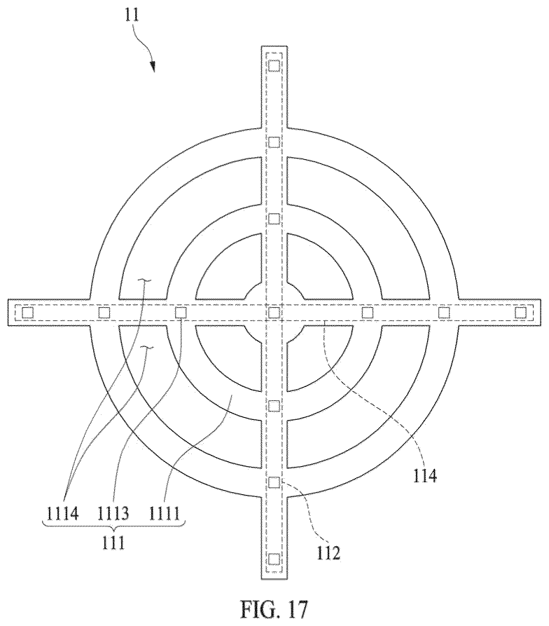

FIG. 17 is a plan view of a signal measuring device configured to adjust a contact pressure to an object according to one or more embodiments.

Referring to FIG. 17, the signal measuring device 11 according to one or more embodiments may include the electrode layer 111 and the pressure channels 112 and 114. The electrode layer 111 may include the insulator 1111, an electrode line (e.g., 1112 of FIG. 1), the electrode pad 1113, and a hole 1114. The pressure channels 112 and 114 may include the first pressure channel 112 and the second pressure channel 114 disposed in different directions.

For example, the mesh structure of the insulator 1111 may include a plurality of concentric structures having different diameters. For example, the plurality of holes 1114 may become wider as moving outward from the center of the electrode layer 111. That is, the plurality of holes 1114 may become wider or have more surface area along a radially outward direction extending from a center of the insulator 1111. For example, when the plurality of holes 1114 are formed in a uniform size regardless of positions, while the signal measuring device 11 encloses a 3D stereoscopic object (e.g., O of FIG. 1), more wrinkles may occur as a portion away from the center folds compared to a portion close to the center of the signal measuring device 11. In other words, the possibility that contact between the object O and the electrode pad 1113 positioned in the outer side of the plurality of electrode pads 1113 is interfered by the wrinkles may increase. However, the example structure of FIG. 17 may decrease the phenomenon.

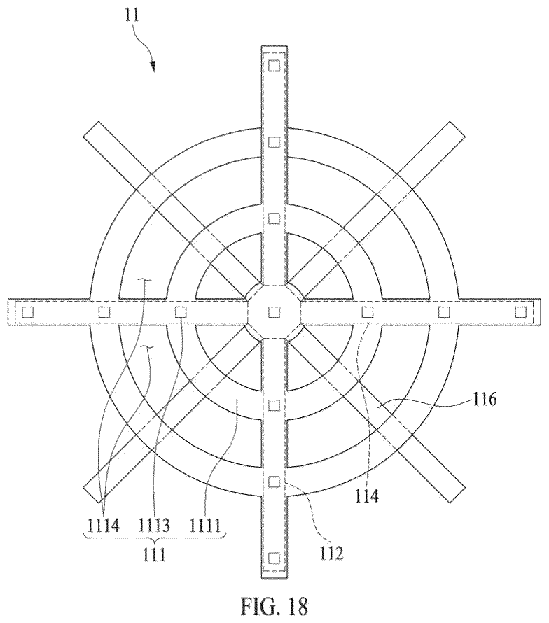

FIG. 18 is a plan view of a signal measuring device configured to adjust a contact pressure to an object according to one or more embodiments.

Referring to FIG. 18, the signal measuring device 11 according to one or more embodiments may include the electrode layer 111 and pressure channels 112, 114, and 116. The electrode layer 111 may include the insulator 1111, an electrode line (e.g., 1112 of FIG. 1), the electrode pad 1113, and a hole 1114.

The pressure channels 112, 114, and 116 may include, for example, the first pressure channel 112, the second pressure channel 114, and the third pressure channel 116 disposed in different directions. For example, the plurality of pressure channels 112, 114, and 116 may be radially disposed. The configuration described above may allow the signal measuring device 11 to be deformed in various directions without designing the plurality of pressure channels 112, 114, and 116 to intersect with each other.

For example, based on the thickness direction of the electrode layer 111, some pressure channels 112 and 114 of the plurality of pressure channels 112, 114, and 116 may be disposed to be completely overlapped by the insulator 1111 and the other pressure channel 116 may be disposed to be partially overlapped by a portion of the insulator 1111.

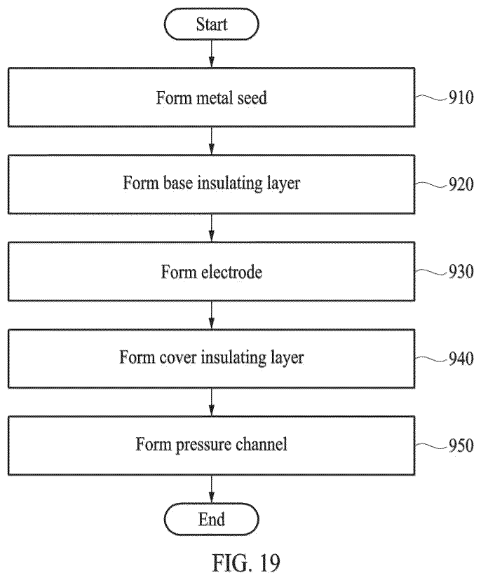

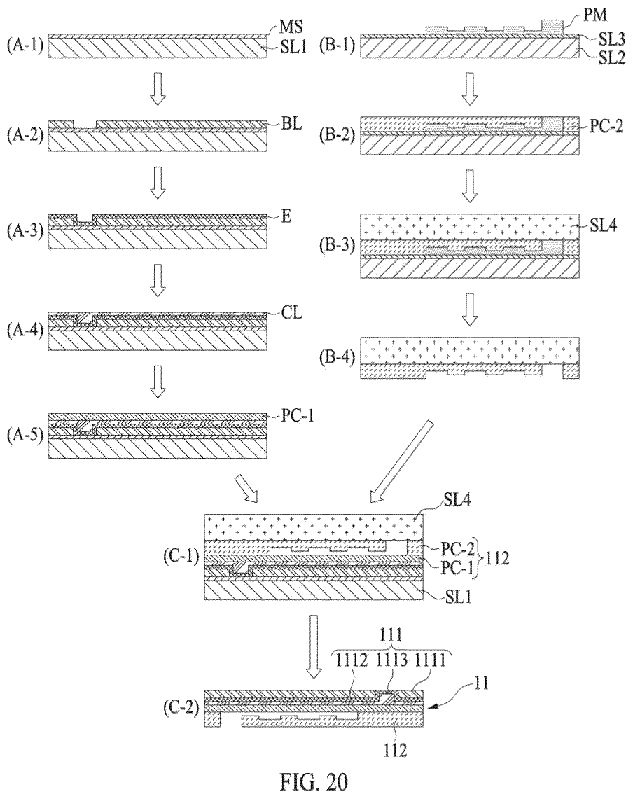

FIG. 19 is a flowchart illustrating a method of manufacturing a signal measuring device configured to adjust a contact pressure to an object according to one or more embodiments. FIG. 20 is a diagram illustrating a method of manufacturing a signal measuring device capable of contact pressure adjustment according to one or more embodiments.

Referring to FIGS. 19 and 20, according to a method of manufacturing the signal measuring device 11 in one or more embodiments, a 3D structure may be manufactured by a 2D manufacturing process. According to the manufacturing method in one or more embodiments, the signal measuring device 11 including a micro-sized electrode may be manufactured. The manufacturing method in one or more embodiments may include operation 910 of forming a metal seed, operation 920 of forming a base insulating layer, operation 930 of forming an electrode, operation 940 of forming a cover insulating layer, and operation 950 of forming a pressure channel.

In operation 910, as shown in A-1 of FIG. 20, a metal seed MS may be formed on a first sacrificial layer SL1. The first sacrificial layer SL1 may be, for example, a wafer formed of silicon (Si). The first sacrificial layer SL1 may be a layer functioning as a carrier substrate required to form a portion of the signal measuring device 11 and may be removed after manufacturing the signal measuring device 11 is completed or while manufacturing is in progress. Unless otherwise described, the description of the first sacrificial layer SL1 may apply to other sacrificial layers SL2, SL, and SL4. For example, in operation 910, the metal seed MS may be formed by depositing a metallic material on the first sacrificial layer SL1.

In operation 920, for example, as shown in A-2 of FIG. 20, a base insulating layer BL may be formed on the metal seed MS. The base insulating layer BL may be formed of an insulating material and may form at least a portion of the insulator 1111. For example, the base insulating layer BL may be formed of a flexible material. For example, the insulating material may include a polymeric silicone material (e.g., PDMS), a photoresist (e.g., SU-8), parylene (e.g., parylene C), or a polyimide material. For example, in operation 920, after applying the insulating material to the metal seed MS, the base insulating layer BL including a space in which an electrode E (e.g., the electrode line 1112 and/or the electrode pad 1113) is formed may be formed by performing a photo process (e.g., an exposure process and a development process) and/or an etching process.

In operation 930, for example, as shown in A-3 of FIG. 20, the electrode E may be formed. For example, in operation 930, by depositing the metallic material on the base insulating layer BL, at least a portion of the electrode E may be formed. For example, in operation 930, after the metallic material is deposited, the electrode E may be patterned using the photo process and/or the etching process.

In operation 940, for example, as shown in A-4 of FIG. 20, a cover insulating layer CL may be formed to cover the electrode E. The cover insulating layer CL may be formed of an insulating material and may form at least of a portion of the insulator 1111. For example, the cover insulating layer CL may be formed of a flexible material. Unless otherwise described, a layer formed in each process may be formed using the photo process and/or the etching process. For example, by iteratively performing the process described above, a plurality of electrodes E positioned at different heights may be formed while being electrically separated from each other by the insulating material.

In operation 950, the pressure channel 112 may be formed in the cover insulating layer CL. For example, after the pressure channel 112 is separately formed, the pressure channel 112 may be fixed to the cover insulating layer CL. As another example, a first portion PC-1 of the pressure channel 112 may be formed in the cover insulating layer CL as shown in A-5 of FIG. 20 and a second portion PC-2 of the pressure channel 112 may be formed separately from the first portion PC-1 as shown in B-1 to B-4 of FIG. 20. After the first portion PC-1 and the second portion PC-2 are formed, for example, the pressure channel 112 may be formed by bonding the first portion PC-1 to the second portion PC-2 as shown in C-1 of FIG. 20. For example, when separately forming the first portion PC-1 and the second portion PC-2, the two portions may be formed of different materials. For example, the first portion PC-1 functioning as the top wall of the pressure channel 112 may be formed of a material having a greater elastic coefficient than the second portion PC-2 functioning as the bottom wall of the pressure channel 112, but embodiments are not limited thereto. Hereinafter, in operation 950, a method of separately forming the first portion PC-1 and the second portion PC-2 of the pressure channel 112 and then bonding the first portion PC-1 to the second portion PC-2 is described.

Referring to A-5 of FIG. 20, the first portion PC-1 of the pressure channel 112 may be formed in the cover insulating layer CL. The first portion PC-1 may include, for example, polymeric silicone (e.g., PDMS), a photoresist (e.g., SU-8), parylene, or a polyimide material.

Referring to B-1 of FIG. 20, a pattern mold PM corresponding to the shape of the pressure channel 112 may be formed in the second sacrificial layer SL2. The pattern mold PM may be formed as a shape corresponding to each component (e.g., the channel partition wall or the joint space) of the pressure channel 112. For ease of understanding, the shape of the pattern mold PM is simply illustrated, but the actual shape of the pattern mold PM may be different. The pattern mold PM may include, for example, polymeric silicone (e.g., PDMS), a photoresist (e.g., SU-8), parylene, or a polyimide material. For example, when forming the pattern mold PM using an SU-8 material, rapid patterning may be allowed, a process may be simplified, and the thickness of the pattern mold PM may be easily adjusted, and thereby, the pattern mold PM may be more easily and thinly formed.

For example, before forming the pattern mold PM in the second sacrificial layer SL2, a third sacrificial layer SL3 may be deposited in advance. The third sacrificial layer SL3 may be formed of a metallic material (e.g., aluminum). By the third sacrificial layer SL3, the second portion PC-2 of the pressure channel 112 to be formed later may be easily removed from the second sacrificial layer SL2.

Referring to B-2 of FIG. 20, the second portion PC-2 of the pressure channel 112 may be formed by depositing a flexible material on the pattern mold PM. The second portion PC-2 may include, for example, polymeric silicone (e.g., PDMS), a photoresist (e.g., SU-8), parylene, or a polyimide material. For example, the second portion PC-2 may be formed of a material that is different from the pattern mold PM. For example, the adhesion of the second portion PC-2 to the third sacrificial layer SL3 may be lower than the adhesion of the pattern mold PM to the third sacrificial layer SL3. For example, the adhesion of the pattern mold PM to the second portion PC-2 may be lower than the adhesion of the pattern mold PM to the third sacrificial layer SL3. According to the configuration described above, as described below, when the second sacrificial layer SL2 and the third sacrificial layer SL3 are removed from the second portion PC-2, the pattern mold PM may be easily removed from the second portion PC-2.

Referring to B-3 of FIG. 20, the fourth sacrificial layer SL4 may be attached to the second portion PC-2 of the pressure channel 112. For example, the fourth sacrificial layer SL4 may include a wafer formed of glass or a silicon material. For example, the fourth sacrificial layer SL4 may be formed of a material having greater intensity than the second portion PC-2. Through the configuration described above, as described below, the second portion PC-2 of the pressure channel 112 may be stably bonded to the first portion PC-1.

Referring to B-4 of FIG. 20, after the fourth sacrificial layer SL4 is formed, a portion corresponding to the pattern mold PM in the second portion PC-2 of the pressure channel 112 may be exposed to the outside by removing the second sacrificial layer SL2, the third sacrificial layer SL3, and the pattern mold PM.

Referring to C-1 of FIG. 20, the pressure channel 112 may be formed by bonding the first portion PC-1 to the second portion PC-2. For example, after aligning the first portion PC-1 and the second portion PC-2, the first portion PC-1 may be bonded to the second portion PC-2 by applying heat while pressing the first sacrificial layer SL1 and the fourth sacrificial layer SL4 from both sides.

Referring to C-2 of FIG. 20, while the first portion PC-1 is bonded to the second portion PC-2, the first sacrificial layer SL1 and the fourth sacrificial layer SL4 may be removed. Through the example process described above, the signal measuring device 11 including the pressure channel 112 and the electrode layer 111 including the insulator 1111, the electrode line 1112, and the electrode pad 1113 may be formed.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Each of the embodiments provided in the above description is not excluded from being associated with one or more features of another example or another embodiment also provided herein or not provided herein but consistent with the disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A signal measuring device configured to adjust a contact pressure to an object, the signal measuring device comprising:
an electrode layer comprising at least one electrode pad configured to receive an electrical signal from the object; and
a first pressure channel on the electrode layer and configured to deform the electrode layer in a direction in which the electrode pad contacts the object based on pressure being applied in the first pressure channel.

2. The signal measuring device of claim 1, wherein the electrode layer further comprises an insulator comprising a front surface facing the object and a rear surface opposite to the front surface,
wherein the first pressure channel comprises a channel outer wall comprising a side wall and a bottom wall positioned farther from the front surface than the side wall, and
wherein an elastic coefficient of the bottom wall is less than an elastic coefficient of the insulator.

3. The signal measuring device of claim 2, wherein a thickness of the bottom wall is less than a thickness of the insulator.

4. The signal measuring device of claim 2, wherein a material forming the bottom wall is different than a material forming the insulator.

5. The signal measuring device of claim 2, wherein the at least one electrode pad comprises a plurality of electrode pads, and
wherein the plurality of electrode pads are arranged in the insulator along a direction parallel with a longitudinal direction along which the first pressure channel extends.

6. The signal measuring device of claim 2, wherein the first pressure channel comprises:
a channel partition wall partitioning an internal space of the first pressure channel;
a plurality of joint spaces partitioned by the channel partition wall; and
a flow path configured to connect the plurality of joint spaces to each other.

7. The signal measuring device of claim 6, wherein the flow path is between the channel partition wall and the insulator.

8. The signal measuring device of claim 6, wherein the flow path penetrates the channel partition wall.

9. The signal measuring device of claim 2, wherein the at least one electrode pad comprises a plurality of first electrode pads and a plurality of second electrode pads,
wherein the plurality of first electrode pads are arranged along a first longitudinal direction in the insulator, and
wherein the plurality of second electrode pads are arranged along a second longitudinal direction that intersects with the first longitudinal direction in the insulator.

10. The signal measuring device of claim 9, further comprising a second pressure channel extending along in a third longitudinal direction that intersects a fourth longitudinal direction along which the first pressure channel extends.

11. The signal measuring device of claim 10, wherein each of the first pressure channel and the second pressure channel comprises:
a channel partition wall partitioning an internal space of the respective pressure channel;
a plurality of joint spaces partitioned by the channel partition wall; and
a flow path configured to connect the plurality of joint spaces to each other.

12. The signal measuring device of claim 11, wherein more than half of the plurality of joint spaces of the first pressure channel do not overlap the second pressure channel.

13. The signal measuring device of claim 11, wherein, based on a thickness direction of the electrode layer, the channel partition wall of the first pressure channel overlaps the second pressure channel.

14. The signal measuring device of claim 12, wherein the first pressure channel and the second pressure channel intersect each other at a same height.

15. The signal measuring device of claim 14, wherein the first pressure channel and the second pressure channel share a shared channel partition wall,
wherein a first flow path extending in the fourth longitudinal direction along which the first pressure channel extends and a second flow path extending in the third longitudinal direction along which the second pressure channel extends are in the shared channel partition wall, and
wherein the first flow path is not connected to the second flow path.

16. The signal measuring device of claim 2, wherein the electrode layer further comprises a plurality of holes penetrating the insulator, and
wherein the insulator comprises a mesh structure.

17. The signal measuring device of claim 16, wherein, based on a thickness direction of the electrode layer, an area in which the first pressure channel is overlapped by the plurality of holes is less than 50% of a total area of the plurality of holes.

18. The signal measuring device of claim 16, wherein an area of the plurality of holes increases along a radially outward direction from a center of the electrode layer.

19. A signal measuring apparatus configured to adjust a contact pressure to an object, the signal measuring apparatus comprising:
a signal measuring device comprising:
an electrode layer comprising an electrode pad configured to receive an electrical signal from the object; and
a pressure channel configured to deform the electrode layer in a direction in which the electrode pad contacts the object based on pressure being applied in the pressure channel;
a pressure application device configured to supply fluid to the pressure channel; and
a controller configured to control the pressure application device.

20. The signal measuring apparatus of claim 19, wherein the controller is configured to control the pressure application device to increase pressure of the pressure channel based on the electrical signal obtained from the electrode pad being less than a set value.
